(19) United States
(12) Patent Application Publication
(10) Pub. No.: US 2011/0092188 A1
(43) Pub. Date: Apr. 21, 2011

(54) Enhanced Voice Mail System for Accessing RSS (Really Simple Syndication) Feeds

(75) Inventor: Jonas Johansson, Saint Laurent (CA)

(73) Assignee: TELEFONAKTIEBOLAGET LM ERICSSON (PUBL), Stockholm (SE)

(21) Appl. No.: 12/580,899

(22) Filed: Oct. 16, 2009

(51) Int. Cl. H04M 3/00; H04W 4/00

(52) U.S. Cl. 455/412.2; 455/466

(57) ABSTRACT

A method and an enhanced voice mail system for subscribing to RSS (Really Simple Syndication) feeds on behalf of a user are provided. The enhanced voice mail system subscribes with RSS server(s) to obtain one or more RSS feeds for a user and further obtains the RSS feeds media content referred to within the RSS feeds. The received media content may be transcoded if needed, for example to adapt to the media format supported by the voice mail system, and then stored in the enhanced voice mail system. The later further notifies the user of the availability of the RSS feeds media content, possibly using e.g. SMS notifications. The voice mail system therefore enhances the user experience by extending its functionality beyond the simple handling of user-to-user voice mail messages. The user can then connect to their mailbox of the enhanced voice mail system and get access not only to voice mail messages left by other users, but also to RSS feeds media content.

### TECHNICAL FIELD

The present invention relates to voice mail systems.

### BACKGROUND

Voice mail systems are known for a long time in telecommunications networks. They allow users (e.g. mobile users) to deliver voice mail messages to mailboxes of other user, when the later are unavailable. Typically, when for example user A calls user B and user B is busy or otherwise unavailable, the call is routed to the voice mail system of user B, where user A has the possibility to record a voice message for user B, and the message gets deposited user B's voice mailbox. The later is then notified by the voice mail system, typically via an SMS (Short Message Service) notification, of the existence of a pending voice mail message, and can then connect to his voice mail system via a voice connection, to listen to the message.

Voice mail systems have only slightly evolved over the years. They still necessitate a dedicated voice connection both for the recordation of the voice messages and their delivery. They likewise serve only a unique purpose, i.e. to store voice mail messages received from other users, and as such they only provide little flexibility. Currently, voice messages are only retrieved via a circuit switched phone call (PSTN, i.e. the Public Switched Telephone Network, and/or PLMN, i.e. the Public Local Mobile Network) and typically require the users' attention for the entire length of the retrieval session since navigation throughout the messages and the menus of the voice mail system is limited to DTMF (Dual-Tone Multi Frequency) tones from the user. This is at best cumbersome. Finally, in current implementations, it is also preferable that pending messages are retrieved during the retrieval session in order to make space for new ones, or in order not to confuse old and new messages.

Some recent enhancements to voice mail system include the possibility for audio messages pending in a user's voice mail system to be delivered to the user's terminal via email attachments. The Apple Inc.'s Visual Voice Mail Application™ allows a user to deposit a voice message into the voice mail system of another user, and for the voice mail system to deliver the audio message to the recipient user in an email attachments. In such an implementation, all audio messages are thus sent to the recipient user's terminal, where a message browser application allows for some increased flexibility in the messages' manipulation. For example, the user is able to look at the pending messages on a GUI of his terminal and browse through the available messages to choose which ones to be listened first, based on the displayed originating user ID of each message.

However, in all available implementation, current voice mail systems are limited to handling voice mail messages left by other users, and as such, they only provide limited flexibility and value for the users.

Although there is no prior art solution as the one proposed hereinafter for solving the above-mentioned deficiencies, the US patent publication US-20080013697 bears some relation with the field of the present invention. This US patent publication teaches a method for retrieving a voicemail message from a client/server communication network using a mobile device. The method includes the steps of sending a voicemail retrieval request from the mobile device to the client/server communication network, then generating an RSS (Really Simple Syndication) feed at the client/server communication network. The method further generates an audio file that corresponds to the voicemail message at the client/server communication network and downloads the RSS feed and the audio file to the mobile device.

### SUMMARY

It is therefore a general object of this invention to provide a method and voice mail system for overcoming at least some of the prior art drawbacks.

A method and an enhanced voice mail system for subscribing to RSS (Really Simple Syndication) feeds on behalf of a user are provided according to the preferred embodiment of the invention. The enhanced voice mail system subscribes with RSS server(s) to obtain one or more RSS feeds for a user and further obtains the RSS feeds media content referred to within the RSS feeds. The received media content may be transcoded if needed, for example to adapt to the media format supported by the voice mail system, and then stored in the enhanced voice mail system. The later further notifies the user of the availability of the RSS feeds media content, possibly using e.g. regular SMS (Short Messaging Service) notifications. The voice mail system therefore enhances the user experience by extending its functionality beyond the simple handling of user-to-user voice mail messages. The user can then connect to their mailbox of the enhanced voice mail system and get access not only to voice mail messages left by other users, but also to RSS feeds media content.

In one aspect, the present invention is a method for voice mail system access, the method allowing a voice mail system to subscribe with an RSS (Really Simple Syndication) server to obtain one or more RSS feeds for a user. The voice mail system further obtains RSS feeds media content referred to within at least one of the RSS feeds, and stores the RSS feeds media content referred to within the at least one of the RSS feeds. The voice mail system then notifies the user of the availability of the RSS feeds media content.

In another aspect, the present invention is a voice mail system comprising an RSS feeds communication interface subscribing with an RSS server to obtain one or more RSS feeds for a user and for further obtaining RSS feeds media content referred to within at least one of the RSS feeds. The voice mail system further comprises an RSS feeds media content database storing the RSS feeds media content referred to within the at least one of the RSS feeds. Finally, the voice mail system comprises a user communication interface notifying a user of the availability of the RSS feeds media content.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 is a high level network diagram of an exemplary network implementing the preferred embodiment of the present invention;

FIG. 2 is a nodal operation and signal flow diagram of an exemplary implementation of the preferred embodiment of the present invention in a telecommunications network;

FIG. 3 is a block diagram of an exemplary voice mail system implementing the preferred embodiment of the present invention; and

FIG. 4 is a flowchart diagram of an exemplary method implementing the preferred embodiment of the invention.

### DETAILED DESCRIPTION

The innovative teachings of the present invention will be described with particular reference to various exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views.

The embodiments according to the present invention are described with reference to block diagrams and/or operational illustrations of methods, servers, and computer program products. It is to be understood that each block of the block diagrams and/or operational illustrations, and combinations of blocks in the block diagrams and/or operational illustrations, can be implemented by radio frequency, analog and/or digital hardware, and/or computer program instructions and/or products. Thus, the various aspects of the invention may be embodied in many different forms, and all such forms are contemplated to be within the scope of the invention. The computer program instructions may be provided to a processor circuit of a general purpose computer, special purpose computer, ASIC, and/or other programmable data processing apparatus, such that the instructions, which execute via the processor of the computer and/or other programmable data processing apparatus, create means for implementing the functions/acts specified in the block diagrams and/or operational block or blocks. In some alternate implementations, the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Furthermore, in some illustrations, some blocks may be optional and may or may not be executed.

It is an object of the present invention to provide an enhanced voice mail system that can not only handle voice mail messages left by users for other users (also called herein user-to-user messages), but that can further accept other types of messages ore media content, e.g. audio or video, such as for example, RSS feeds media content. According to the preferred embodiment of the invention, such an enhanced voice mail system is capable to store those RSS feeds messages in an enhanced user's mailbox for user retrieval. One advantage of such a system is that it improves the user's experience and provides an extended usage for the voice mail system, beyond the simple handling of user-to-user voice mail messages. Provided with such an enhanced voice mail system, a user can for example configure his mailbox to, for example, subscribe to RSS feeds (e.g. news, weather forecast, etc) on his behalf so that the RSS feeds media content, in audio or even in video format, is obtained and downloaded in the user's mailbox on the voice mail system, is converted in the proper voice mail system format if needed, and is then made available to the user just like the user-to-user audio messages.

A more detailed description of the RSS feeds may be needed for a better understanding of the present invention. RSS (Really Simple Syndication) are used to publish content that may include news, weather forecast, or other audio/video content. An RSS feed is typically an XML document (also sometimes called a feed, web feed, or channel) that includes the RSS feed's title, author, publication date, and a reference (e.g. a link) to the actual RSS feed media content. The use of a standardized XML file format enables information to be published once and viewed by many different programs. A user can for example subscribe to a feed by entering into a reader application the feed's URI or by clicking an RSS icon in a browser that can trigger the subscription process. The RSS reader application can then check the subscribed feeds regularly for new work, can download updates it finds, and provide a user interface to monitor and read the feeds.

Thus, an RSS feed is a document (often XML-based) whose content items may include web links to the source of the RSS feed media content. An example of such an XML file is provided below. One can notice first the RSS feed header containing for example the title of the RSS feed and the http link to the source of the RSS feed, and a description of the feed. Then the RSS feed may further comprise one or more RSS feed chapters, that contain the link to the actual content of the RSS feed.

The Exemplary RSS feed:

<?xml version=“1.0” encoding=“UTF-8”?>
<rss version=“2.0” xmlns:dc=“http://purl.org/dc/elements/1.1/”>
<channel>

<title>Cleaning Office Podcast</title>
<link>http://www.acoustica.com/mixcraft/tutorial/v3/How-

To-Create-A-Podcast.htm</link>

<description>This is an example podcast of three

| | | |
|---|---|---|
| RSS Feed | {open oversize brace} | episodes, where I discuss the cleaning of the office with a |
| Header | | terrible German accent.</description> |

<language>en-us</language>
<copyright>Acoustica, Inc. All Rights Reserved</copyright>
<lastBuildDate>Tue, 1 May 2007 16:12:44

GMT</lastBuildDate>

<ttl>60</ttl>
<item>

<title>Cleaning Office Podcast</title>

<link>http://www.acoustica.com/mixcraft/tutorial/podcast/01
. Cleaning Office Podcast.MP3</link>

<description>First cleaning installment (Running Time

02:54)</description>

<pubDate>Tue, 1 May 2007 16:08:53 GMT</pubDate>
<enclosure

| | | |
|---|---|---|
| RSS Feed | {open oversize brace} | url=“http://www.acoustica.com/mixcraft/tutorial/podcast/01. |
| Chapter | | Cleaning Office Podcast.MP3” length=“526296” |
| | | type=“audio/mpeg”/> |

</item>

<item>

<title>Cleaning Office Podcast</title>

</channel>
</rss>

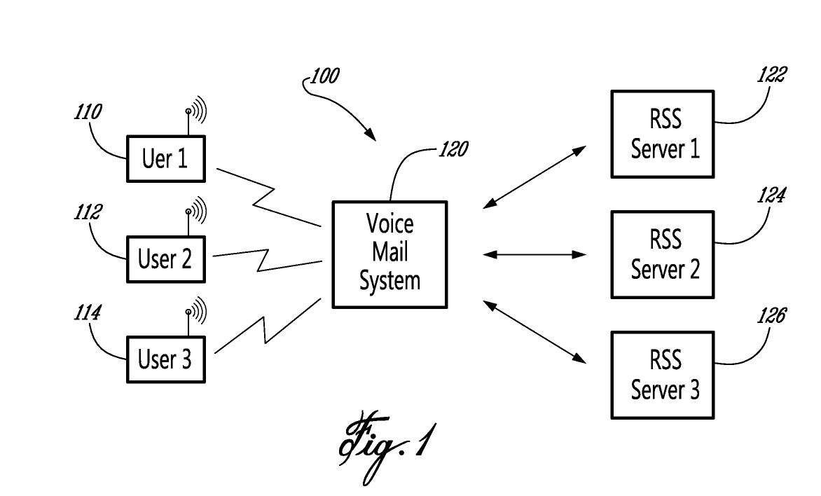

Reference is now made to FIG. 1 which is a high level network diagram of an exemplary network 100 implementing the preferred embodiment of the present invention. The network 100 may be a PLMN (or also a PSTN) serving a plurality of terminals 110-114 (e.g. mobile terminals in case of a PLMN), and comprising at least an enhanced voice mail system 120 according to the present invention. The system 120 is operationally connected to the terminals via the appropriate communications interfaces and links (not shown). For example, in case the network 100 is a PLMN, the network may comprise base stations, base station controllers, mobile switching centers, and home location registers enabling wireless service support and connections for the terminals 110-114. Shown also in the network 100 are 3 exemplary RSS feed servers 122-126 operationally connected to the voice mail system 120 via appropriate communication interfaces and communication links, such as for example via the Internet. Thus, it is to be understood that the network 100 typically comprises many more terminals and other functional nodes which are however omitted in the present exemplary representation for simplicity purposes. According to the present invention, the voice mail system 120 may be configured to subscribe to other servers for obtaining certain types of information, such as for example to subscribe for RSS feeds with the servers 122-126, so that RSS feeds media content is downloaded, not directly to the user terminals as in the prior art, but rather into the mailboxes of the users of the voice mail system 120. The downloaded RSS feed media content is then made available by the voice mail system for user retrieval. When the users then connect to their mailboxes they can browse the RSS messages just like they browse their voice mail messages, and are therefore provided with an enhanced experience of their voice mail system.

One of the advantages of such a voice mail system is that it can allow users to have access to their preferred RSS feeds even without an Internet connection, since the connection to the voice mail system may in certain instances be made via only a voice connection over e.g. a circuit switch link.

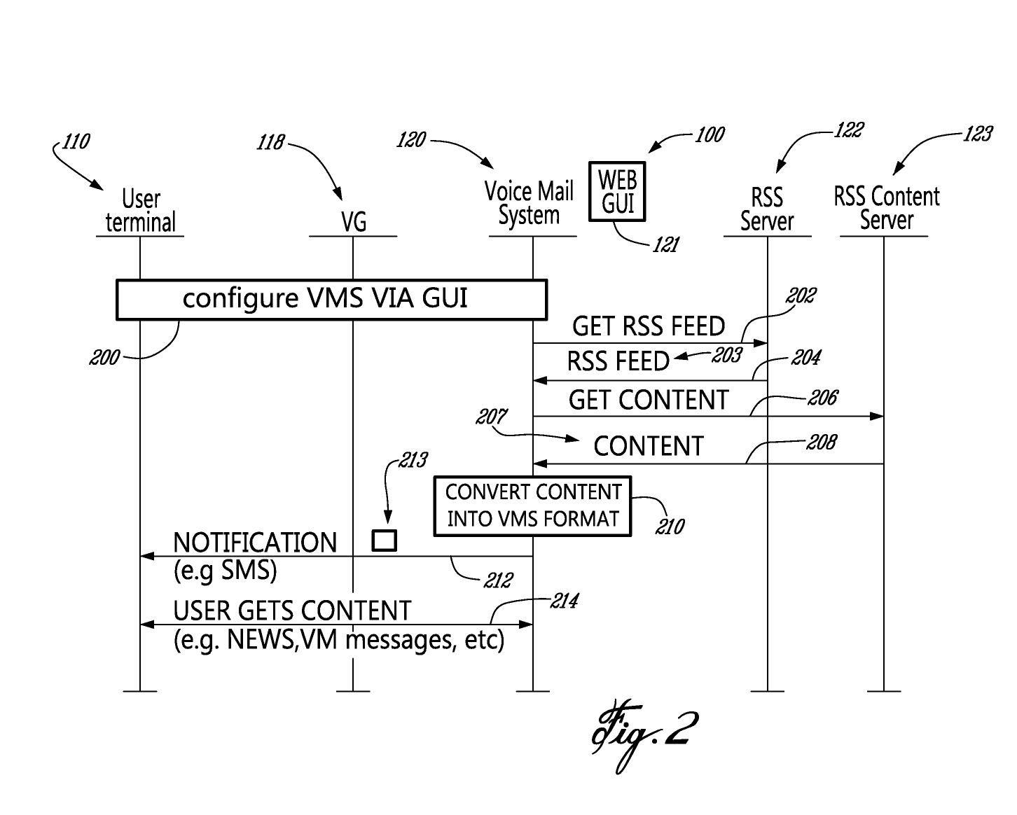

FIG. 2 is a nodal operation and signal flow diagram of an exemplary implementation of the preferred embodiment of the present invention in the telecommunications network 100 described herein before. Shown in the network 100 of FIG. 2 are the same user terminal 110 and the voice mail system 120 that comprises a Web GUI 121 allowing users to configure their mailboxes residing on the system 120 in order to subscribe to certain types of information, such as for example to RSS feeds on their behalf. Further shown in FIG. 2 are an exemplary RSS server 122 storing RSS feeds, and an RSS content server 123 that stores the RSS feeds content related to the feeds of the RSS server 122. It is to be noticed that in some implementations, the RSS feeds (XML documents) are stored in an RSS feed server alike the server 122 while the content those RSS feeds refer to (via the http link contained therein) is stored in an RSS content server alike the server 123 that is separate and apart from the former. Finally, also shown in FIG. 2 is an optional Voice mail system Gateway (VG) 118 that may act, when needed, as a gateway between the circuit switched world (PSTN/PSLM) and the packaged switched (PS) world (TCP/IP). For example, if in FIG. 2 the user terminal 110 is a circuit switched terminal and the voice mail system 120 is IP-based, then the VG 110 may act as an interface between the circuit switch network and the IP-based voice mail system 120.

In action 200, the user of the user terminal 110 configures his mailbox on the voice mail system 120, via the web GUI 121, in order to subscribe to one or more RSS feeds from the RSS server 122. Once the mailbox of the user is so configured, the voice mail system 120 proceeds to obtain the subscribed content and for this purpose may issue a request, action 202, for the RSS feed the user has subscribed to, which is sent to the RSS server 122. Such a request may take various forms including that of an HTTP GET message. The RSS server 122 returns the RSS feed 203 (e.g. the RSS feed XML file) in action 204. Being provided with the RSS feed, the voice mail system 120 now knows the HTTP link, obtained from the RSS feed file, and can connect to the RSS content server 123 referred to in the link to obtain the RSS feeds media content referred to within the RSS feed. Thus, the voice mail system 120 connects to the RSS content server 123, action 206, and obtains the RSS feeds media content 207 in action 208.

In action 210, the voice mails system may perform whatever conversion or transcoding is necessary on the RSS feed media content 207, in order to be able to store the content in a format that is specific to and that can be handled by the voice mail system. For example, if the content 207 is an mp3 audio file received from an RSS content server of BBC news channel, the voice mail system 120 may need to convert the content 207 in a different audio format supported locally. Also part of action 210 is the local storage of the RSS feeds media content 207, or of the corresponding transcoded content.

Further, in action 212, the voice mails system notifies the user terminal 110 of the availability of the RSS feeds media content 207 in the voice mail system 120. Such a notification may be carried out e.g. via an SMS message informing that (a) new message(s) is/are pending in the user's mailbox on the voice mail system 120 for the user. This notification may be, for example, the same as the one used for regular user-to-user voice messages pending in the user's mailbox, or alternatively may further include an optional indication 213 that the available content is an RSS feed content. Responsive to the notification 212, the user of the user terminal 10 may connect in action 214 to his mailbox and listen to its content, including to the RSS feed media content 207. For example, for sending the RSS feeds media content 207 to the user, the voice mail system and the user terminal 110 may establish a voice connection over a circuit switched network, or alternatively a packet switched media connection, so that the RSS feeds media content 207 is played, or otherwise streamed, from the voice mail system 120 to the user terminal 110.

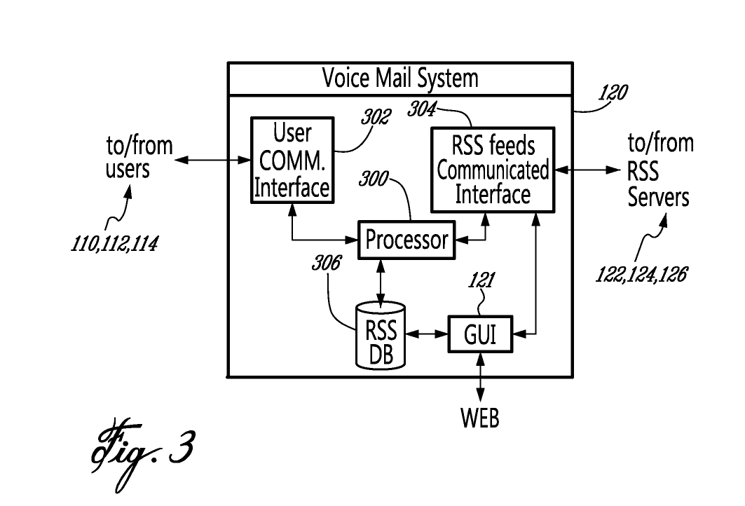

FIG. 3 is a block diagram of an exemplary voice mail system 120 implementing the preferred embodiment of the present invention. The exemplary voice mail system 120 comprises the web GUI 121 allowing users to connect via the Internet to the voice mail system 120 in order to initially configure their mailboxes and to subscribe to desired information, such as for example to RSS feeds. The system 120 also comprises an RSS feeds communication interface (or RSS feeds client) 304 that based on the user configuration performed via the web GUI 121 subscribes with RSS servers to obtain one or more RSS feeds for a user and to further obtaining RSS feeds media content referred to within at least one of the RSS feeds. For this purpose, the RSS feed communication interface 304 issues the RSS feeds subscriptions (e.g request 202) towards the RSS servers 122, 124, and 126, on behalf of the subscribing user, and obtains back the RSS feeds (e.g. the RSS feed 203) and associated RSS feeds media content (e.g. 207). The RSS feed media content 207 may then be sent from the RSS feeds communication interface 304, via appropriate communication links, to the processor 300 of the voice mail system 120 in order to be processed and transcoded or converted, as in the action 210, and then further sent from the processor 300 to the RSS feeds media content database 306 for storage. In one possible embodiment, the database 306 may be the same database used for storing user-to-user messages within the voice mail system 120. The user communication interface 302 of the voice mail system is further responsible to notify the user of the availability of the RSS feeds media content or any new pending messages, and to sustain a proper voice or video connection with the user terminals for the pending messages and RSS feeds media content of the database 306 to get transferred to the users. For example, after storing the media content onto the database 306, the processor 300 may instruct the user communication interface to send out the notification 212 to the user terminal 110, and in action 214, to extract the RSS feeds media content from the RSS feeds content database 306 and send it to the user communication interface 302 for the content 207 to be sent to the user terminal. For example, for sending the RSS feeds media content 207 to the user, the user communication interface 302 of the voice mail system 120 and the user terminal 110 may establish a connection (voice, or multimedia) so that the RSS feeds media content 207 is played, or otherwise streamed, from the voice mail system 120 to the user terminal 110. Therefore, both voice and video RSS feeds media content can be supported by the enhanced voice mail system 120.

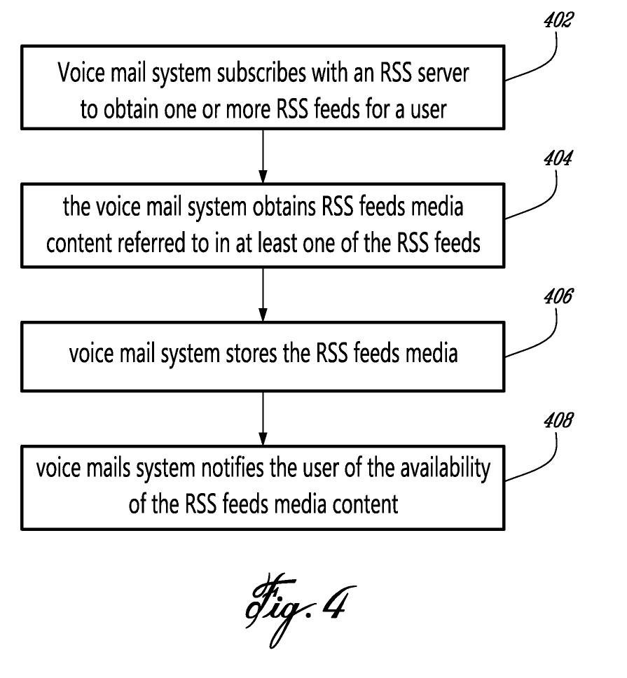

FIG. 4 is a flowchart diagram of an exemplary method implementing the preferred embodiment of the invention. In FIG. 4, first in action 402 the voice mail system subscribes with an RSS feeds server to obtain one or more RSS feeds for a user. In action 404, the voice mail system obtains RSS feeds media content referred to in at least one of the RSS feeds, and in action 406 the voice mail system stores the RSS feeds media, e.g. in a database. Finally, in action 408 the voice mails system notifies the user of the availability of the RSS feeds media content, so that the later can connect and get access to the media content.

Therefore, with the present invention it becomes possible to subscribe on behalf of the user and via a voice mail system to RSS feeds (also known as podcasts/vodcasts) that the user can consume at his/her leisure by connecting to the voice mail system. Notification of said feeds (and it's associated media) can be performed to the subscriber using the voice mail system's existing notification mechanisms, or in some instances with the change that the user is notified that there are new RSS media on the voice mail system to consume (e.g. via the indication 213).

Based upon the foregoing, it should now be apparent to those of ordinary skills in the art that the present invention provides an advantageous solution, which offers an enhanced user experience of voice mail system. Although the system and method of the present invention have been described in particular reference to a “voice mail system”, it should be realized upon reference hereto that the innovative teachings contained herein are not necessarily limited thereto and may be implemented advantageously with any type of media, including not only voice but also images, or video media. It is understood that the RSS feeds media content can therefore comprise one or more of audio media, picture media, text media, or video media. All these types of media can be obtained by the voice mail system 120 from the RSS feeds server and stored in the RSS feeds database, and then transferred to the user terminal via an appropriate type of connection 214 (e.g. voice or multimedia). It is believed that the operation and construction of the present invention will be apparent from the foregoing description. While the method and system shown and described have been characterized as being preferred, it will be readily apparent that various changes and modifications could be made therein without departing from the scope of the invention as defined by the claims set forth hereinbelow.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

1. A method for voice mail system access, the method comprising the steps of:
a voice mail system subscribing with an RSS (Really Simple Syndication) server to obtain one or more RSS feeds for a user;
the voice mail system obtaining RSS feeds media content referred to in at least one of the RSS feeds;
storing in the voice mail system the RSS feeds media; and
the voice mails system notifying a user of the availability of the RSS feeds media content.

2. The method claimed in claim 1 wherein the step of notifying comprises sending an SMS (Short Message Service) notification to the user.

3. The method claimed in claim 1, the method further comprising the step of:
sending the RSS feeds media content from the voice mail system to the user.

4. The method claimed in claim 3 wherein the step of sending the RSS feeds media content to the user comprises playing audio media of the RSS feeds media content over a voice connection established between the voice mail server and the user.

5. The method claimed in claim 1, the method further comprising the step of:
configuring the voice mail system with information related to the one or more RSS feeds the user subscribes to.

6. The method claimed in claim 1 wherein each RSS feed comprises an XML (Extended Mark-Up Language) file.

7. The method claimed in claim 1 wherein following the step of obtaining the content, the method further comprises the step of transcoding the content from its original format in a format used by the voice mail system.

8. The method claimed in claim 1, further comprising, subsequent to the step of subscribing with the RSS server for the one or more RSS feeds, a step of receiving the one or more RSS feeds from at least one RSS server, and further performing the step of obtaining the RSS feeds media content referred to within the at least one of the RSS feeds by requesting the content from an RSS feeds content server referred to in the RSS feeds.

9. The method claimed in claim 1 wherein the voice mail system stores both RSS feeds media content and voice mail messages for the user.

10. A voice mail system comprising:
an RSS (Really Simple Syndication) feeds communication interface subscribing with an RSS server to obtain one or more RSS feeds for a user and obtaining RSS feeds media content referred to in at least one of the RSS feeds;
an RSS feeds media content database storing the RSS feeds media content; and
a user communication interface notifying a user of the availability of the RSS feeds media content.

11. The voice mail system claimed in claim 10 wherein user communication interface sends out an SMS (Short Message Service) notification to the user to notifying a user of the availability of the RSS feeds media content.

12. The voice mail system claimed in claim 10, wherein the user communication interface sends out the RSS feeds media content from the voice mail system to the user.

13. The voice mail system claimed in claim 12 wherein for sending the RSS feeds media content to the user the user communication interface plays audio media of the RSS feeds media content over a voice connection established between the voice mail server and the user.

14. The voice mail system claimed in claim 10, further comprising a web GUI (Graphical User Interface) for configuring the voice mail system with information related to the one or more RSS feeds the user subscribes to.

15. The voice mail system claimed in claim 10 wherein each RSS feed comprises an XML (Extended Mark-Up Language) file.

16. The voice mail system claimed in claim 10 further comprising a processor transcoding the content from its original format in a format used by the voice mail system.

17. The voice mail system claimed in claim 10, wherein the RSS feeds communication interface, subsequent to subscribing with the RSS server for the one or more RSS feeds, receives the one or more RSS feeds from at least one RSS server, and obtains the RSS feeds media content referred to within the at least one of the RSS feeds by requesting the content from an RSS feeds content server referred to in the RSS feeds.

18. The voice mail system claimed in claim 10 wherein the voice mail system stores both RSS feeds media content and voice mail messages for the user.
